(19) United States
(12) Patent Application Publication
(10) Pub. No.: US 2013/0175938 A1
(43) Pub. Date: Jul. 11, 2013

(54) LIGHT SOURCE APPARATUS

(71) Applicants: Ying-Chieh Lu, Zhubei City (TW); Chi-Chang Chen, Zhubei City (TW); Chi-Min Lo, Zhubei City (TW); Kuo-Feng Chiang, Zhubei City (TW)

(72) Inventors: Ying-Chieh Lu, Zhubei City (TW); Chi-Chang Chen, Zhubei City (TW); Chi-Min Lo, Zhubei City (TW); Kuo-Feng Chiang, Zhubei City (TW)

(21) Appl. No.: 13/610,177

(22) Filed: Sep. 11, 2012

(30) Foreign Application Priority Data
Jan. 6, 2012 (TW) 101200382

(51) Int. Cl. H05B 37/02; H05B 37/00

(52) U.S. Cl. 315/201; 315/294

(57) ABSTRACT

A light source apparatus is provided. The light source apparatus comprises an electric-conductive terminal, a control circuit, a first light source device, and a second light source device. The electric-conductive terminal defines a receiving space. The control circuit is disposed within the receiving space of the electric-conductive terminal and is electrically connected to the electric-conductive terminal. The first light source device and the second light source device are both electrically connected to the control circuit. When the control circuit detects a switching signal, the control circuit enables the first light source device to change from a first brightness to a second brightness and enables the second light source device to change from a third brightness to a fourth brightness.

This application claims priority to Taiwan Patent Application No. 101200382 filed on Jan. 6, 2012.

### CROSS-REFERENCES TO RELATED APPLICATIONS

Not applicable.

### BACKGROUND OF THE INVENTION

1. Field of the Invention

The present invention relates to a light source apparatus; more particularly, the present invention relates to a light source apparatus capable of adjusting the brightness according to a switching signal.

2. Descriptions of the Related Art

With the rapid development of science and technologies, different kinds and brightness of light source apparatuses have been available in the market. When disposing light source apparatuses at home, users tend to dispose illumination apparatuses with different brightness and/or different color temperatures according to different scenarios. For example, when not at home or in the evenings, a user may turn off light source apparatuses or turn on a light source apparatus with a weak brightness to maintain a basic indoor brightness and avoid unnecessary consumption of electric power for saving energy and reducing the emission of carbon dioxide. However, the aforementioned approach requires the user to dispose various light source apparatuses of different brightnesses, and the expenses on these light source apparatuses may burden the user.

Furthermore, the illumination effect of light source apparatuses is judged by human eyes, which have different sensitivities to light of different colors. For example, human eyes are more sensitive to green light rather than to red light. Therefore, the selection of color-temperature characteristics of light sources becomes very important for adjusting the brightness to achieve different lighting environments (e.g., in the morning, noon or evening). However, most of the light source apparatuses currently available on the market cannot be adjusted and/or have its color temperature switched. Therefore, if the user desires to achieve the effects of different color temperatures, he or she has to dispose light source apparatuses of different color temperatures. This will also increase the user's expense.

Furthermore, conventional light source apparatuses are controlled by external control circuits. When a control device fails and has to be replaced, it is often necessary to remove the complete lamp. It is extremely inconvenient and consequently reduces the user's willingness to purchase the product.

In view of this, it is important to enhance the user's willingness to purchase the product and, thus, it is necessary to provide a light source apparatus that is easy to operate and is capable of providing different brightnesses/color temperatures.

### SUMMARY OF THE INVENTION

To solve the aforesaid problems, the present invention provides a light source apparatus having a control circuit, which is configured to control the light sources of at least two (or at least two groups of) light source devices so that the light source apparatus can provide the proper brightness.

The light source apparatus provided by the present invention comprises an electric-conductive terminal, a control circuit, a first light source device, and a second light source device. The control circuit is disposed in a receiving space defined by the electric-conductive terminal and is electrically connected to the electric-conductive terminal. Both the first light source device and the second light source device are electrically connected to the control circuit. When a switching signal is detected by the control circuit, the control circuit enables the first light source device to change from a first brightness to a second brightness and enables the second light source device to change from a third brightness to a fourth brightness.

With the technical features disclosed above, the user can adjust the brightnesses of the light source devices in the light source apparatus of the present invention through simple switching. Furthermore, because the control circuit is disposed in a receiving space defined by the electric-conductive terminal, the overall design of the light source apparatus is made simpler. Moreover, when any of the light source devices is damaged, the light source device can be replaced directly. In this way, the difficulty in replacing or maintaining the control circuit of the conventional light source apparatus in the prior art can be avoided.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic block diagram depicting a light source apparatus of a first embodiment;

FIG. 1B depicts the first light source sub-devices and the second light source sub-devices that are arranged alternately;

FIG. 1C depicts the first light source sub-devices and the second light source sub-devices that are arranged alternately; and

FIG. 2 is a schematic view depicting a light source apparatus 2 of a second embodiment.

### DESCRIPTION OF THE PREFERRED EMBODIMENT

In the following descriptions, the light source apparatus provided by the present invention will be explained with reference to embodiments thereof. However, these embodiments are not intended to limit the present invention to any environments, applications or implementations described in these embodiments. Therefore, the description of these embodiments is only for the purpose of illustration rather than to limit the present invention. It shall be appreciated that in the following embodiments and attached drawings, elements not directly related to the present invention are omitted from depiction.

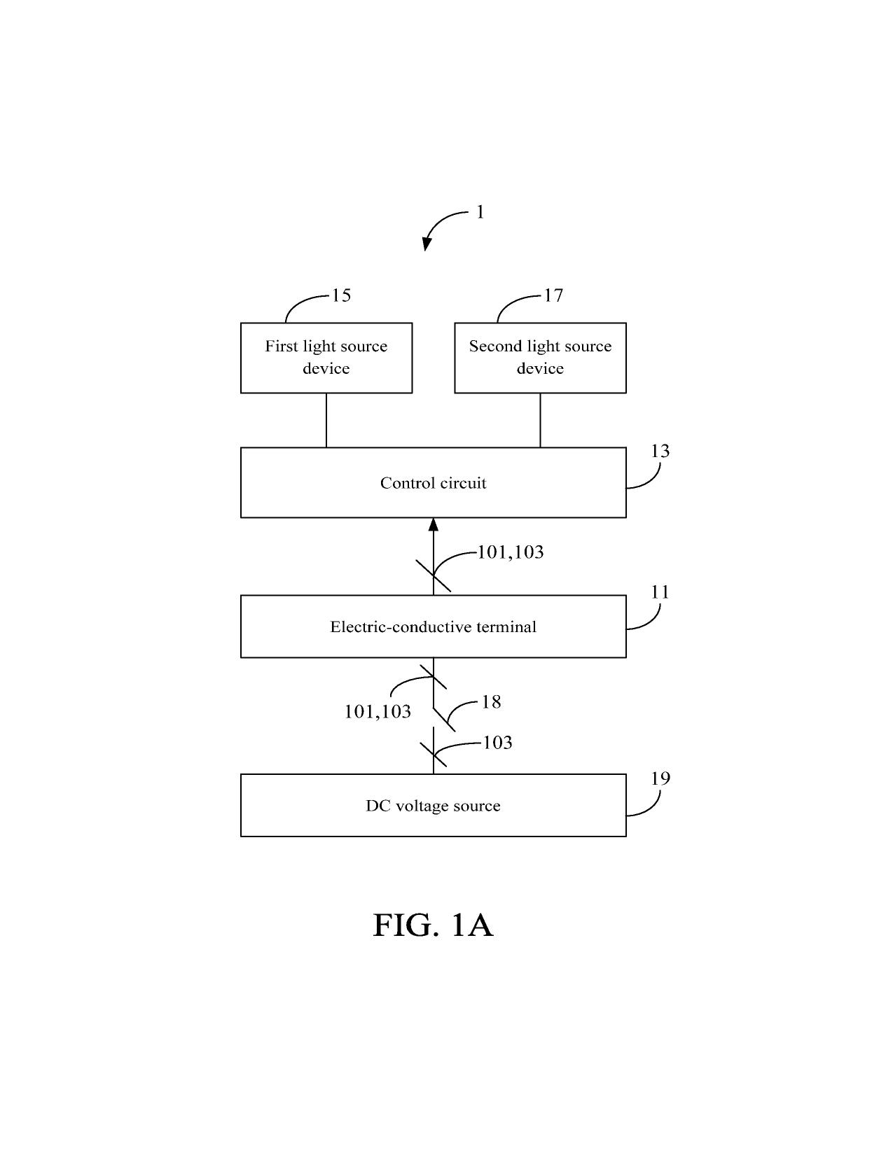

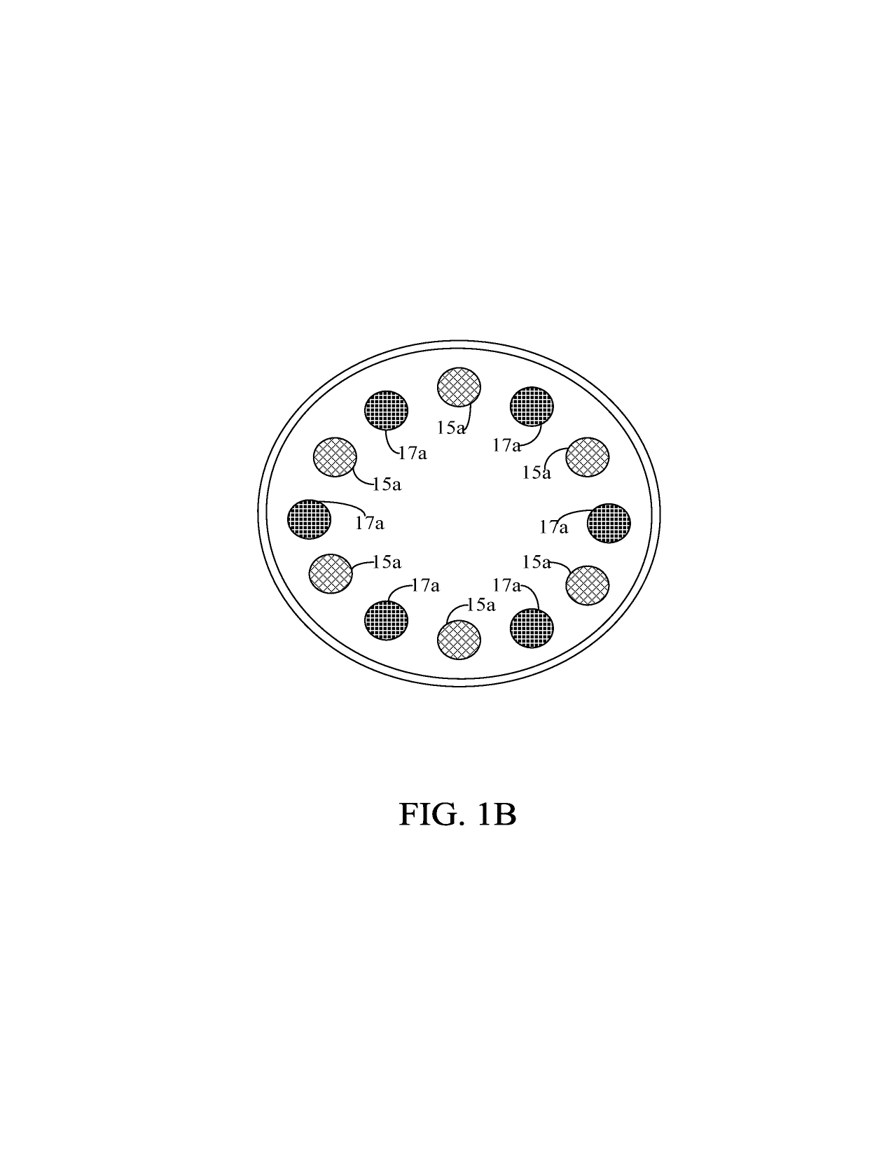

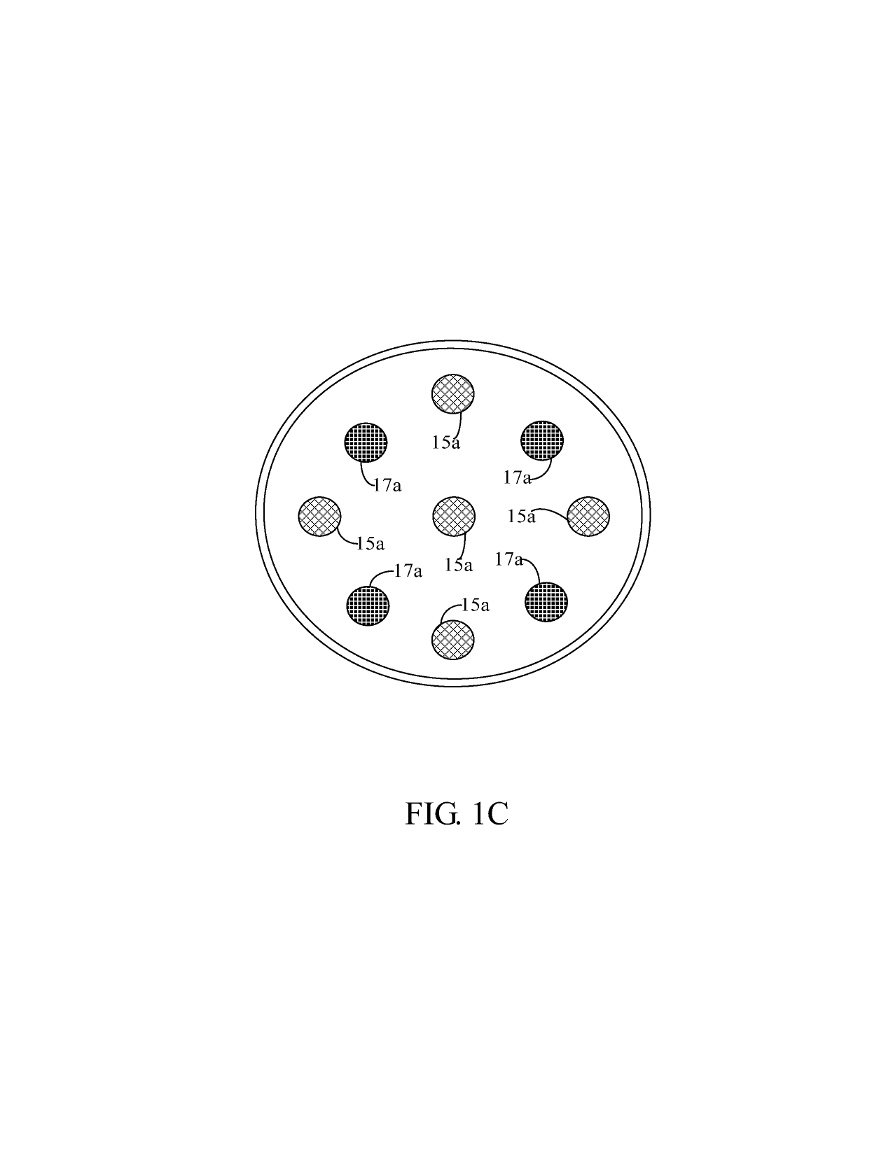

A first embodiment of the present invention is a light source apparatus 1, a schematic block diagram of which is depicted in FIG. 1A. The light source apparatus 1 comprises an electric-conductive terminal 11, a control circuit 13, a first light source device 15, and a second light source device 17. The control circuit 13 is disposed in a receiving space (not shown) defined by the electric-conductive terminal 11 and is electrically connected to the electric-conductive terminal 11. Both the first light source device 15 and the second light source device 17 are electrically connected to the control circuit 13, so the control circuit 13 can control the brightnesses of the first light source device 15 and the second light source device 17.

If the electric-conductive terminal 11 is electrically connected to a switch 18 and the switch 18 is electrically connected to a direct current (DC) voltage source (e.g., a battery) 19, then the light source apparatus 1 can operate. The user may initiate the light source apparatus 1 by activating the switch 18 (e.g., pressing the switch 18 once). After the light source apparatus 1 is initiated, the DC voltage source 19 supplies a DC voltage 103. In the first embodiment, after the light source apparatus 1 is initiated, the first light source device 15 has a first light source brightness, and the second light source device 17 has a third light source brightness.

When the user activates the switch 18 again by pressing the switch 18 once (or pressing the switch 18 multiple times), the switch 18 generates a switching signal 101. When the switching signal 101 is detected by the control circuit 13, the control circuit 13 enables the first light source device 15 to change from the first brightness to a second brightness and enables the second light source device 17 to change from the third brightness to a fourth brightness. When the user activates the switch 18 by pressing the switch 18 multiple times, the switching signal 101 generated by the switch 18 comprises a plurality of switching sub-signals.

It shall be appreciated that the values of the first brightness, the second brightness, the third brightness, and the fourth brightness may be preset by the control circuit 13. For example, the first brightness may be a maximum brightness of the first light source device 15, the second brightness may be a full-dark status, the third brightness may be a full-dark status, and the fourth brightness may be a maximum brightness of the second light source device 17. Therefore, when the switching signal 101 (which may be caused by pressing the switch once or multiple times) is detected by the control circuit 13, the first light source device 15 changes from a full-bright status to the full-dark status, and the second light source device 17 changes from the full-dark status to the full-bright status.

In another example, the first brightness may be the maximum brightness of the first light source device 15, the second brightness may be a half of the first brightness, the third brightness may be a full-dark status, and the fourth brightness may be a half of the maximum brightness of the second light source device 17. Therefore, when the switching signal 101 (which may be generated by pressing the switch once or multiple times) is detected by the control circuit 13, the first light source device 15 and the second light source device 17 change from the full-bright status and the full-dark status to a half of the brightness respectively.

As a further example, the first brightness may be a half of the maximum brightness of the first light source device 15, the second brightness may be the maximum brightness of the first light source device 15, the third brightness may be a half of the maximum brightness of the second light source device 17, and the fourth brightness may also be a full-dark status. Therefore, when the switching signal 101 (which may be generated by pressing the switch once or multiple times) is detected by the control circuit 13, the first light source device 15 and the second light source device 17 change from a half of the brightness to the full-bright status and the full-dark status respectively.

Moreover, the aforesaid examples may be integrated in the control circuit 13 to provide a multi-stage brightness control. For example, when using the three-stage brightness control as an example, a first stage may be one in which the first light source device 15 has the maximum brightness and the second light source device 17 is in the full-dark status, a second stage may be that the first light source device 15 is in the full-dark status and the second light source device 17 has the maximum brightness, and a third stage may be that the first light source device 15 has a half of the maximum brightness thereof and the second light source device 17 has a half of the maximum brightness thereof. When the switch is pressed once at any time instant, a switching signal is detected by the control circuit 13. The control circuit 13 determines that the switching signal comprises only one switching sub-signal and thus, controls the first light source device 15 and the second light source device 17 to present the brightnesses of the first stage. When the switch is pressed twice at any time instant, a switching signal is detected by the control circuit 13. The control circuit 13 determines that the switching signal comprises two switching sub-signals and thus controls the first light source device 15 and the second light source device 17 present the brightnesses of the second stage. Furthermore, when the switch is pressed thrice at any time instant, a switching signal is detected by the control circuit 13. The control circuit 13 determines that the switching signal comprises three switching sub-signals and thus, controls the first light source device 15 and the second light source device 17 to present the brightnesses of the third stage.

It shall be appreciated that the control circuit 13 may control the brightnesses of the first light source device 15 and the second light source device 17 by controlling the power levels thereof. Specifically, when the control circuit 13 enables the first light source device 15 to change from the maximum brightness to a half of the maximum brightness, the control circuit 13 controls the power level of the first light source device 15 to be reduced by a half. In addition, the control circuit 13 controls the brightness of the second light source device 17 in the same way.

Furthermore, in some implementations, the first light source device 15 may comprise a plurality of first light source sub-devices 15a, and the second light source device 17 may comprise a plurality of second light source sub-devices 17a. The first light source sub-devices 15a and the second light source sub-devices 17a are arranged alternately as shown in FIG. 1B and FIG. 1C. Through the alternate arrangement, the brightness of the light source apparatus 1 will be more uniform. It shall be appreciated that FIG. 1B and FIG. 1C are only used to illustrate an implementation of the present invention. The present invention has no limitations on the arrangement, forms, and numbers of the first light source sub-devices 15a and the second light source sub-devices 17a.

Furthermore, the first light source device 15 and the second light source device may have different color temperatures. For example, the first light source device 15 may have a color temperature ranging between 2000K and 3000K, the second light source device 17 may have a color temperature ranging between 5000K and 9000K, or vice versa. If the color temperature of the first light source device 15 ranges between 2000K and 3000K and the color temperature of the second light source device 17 ranges between 5000K and 9000K, then the light source apparatus 1 will have a color temperature ranging between 3000K and 5000K when both the first light source device 15 and the second light source device 17 are initiated.

With the aforesaid arrangement, the user can easily operate the light source apparatus 1 through switching, and the brightness of the light source apparatus 1 can be more uniform by alternately arranging the first light source sub-devices 15a and the second light source sub-devices 17a.

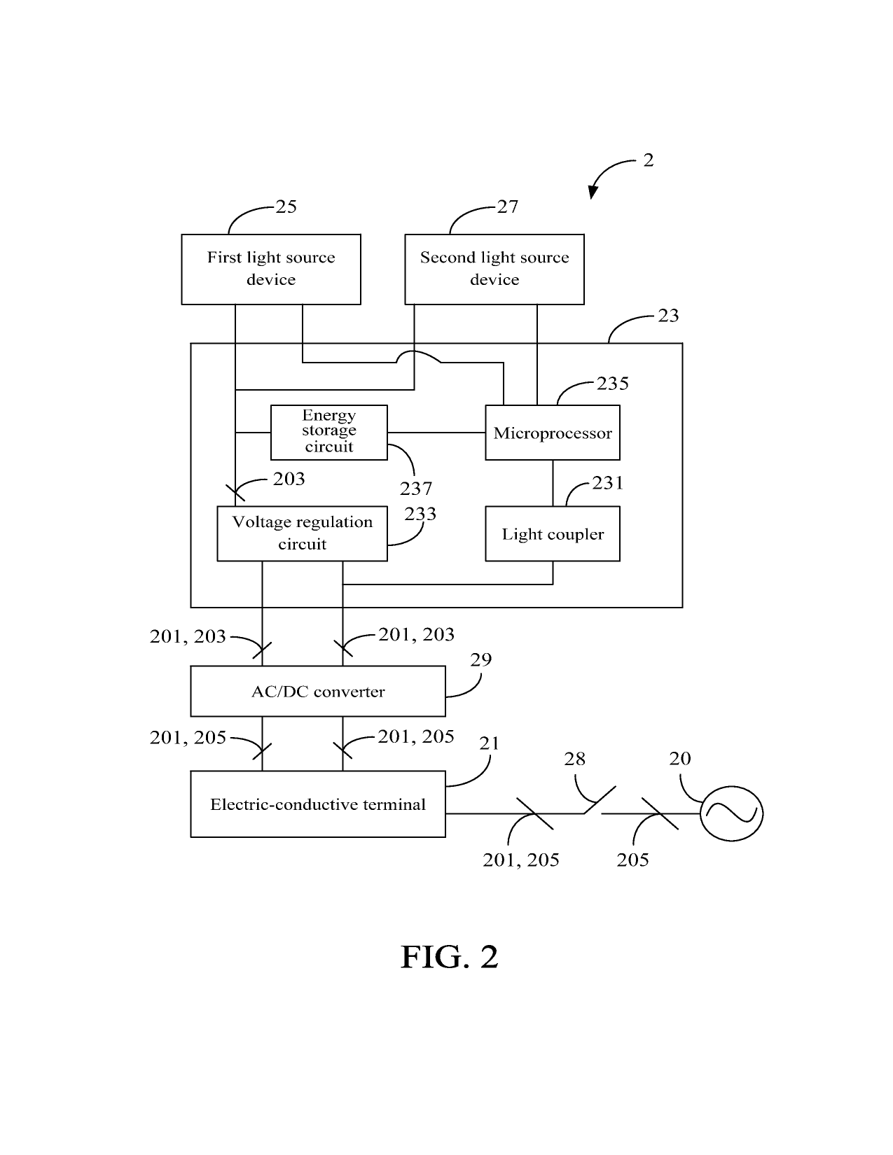

A second embodiment of the present invention is a light source apparatus 2, a schematic view of which is depicted in FIG. 2. The light source apparatus 2 comprises an electric-conductive terminal 21, a control circuit 23 disposed in the electric-conductive terminal 21, an alternating current (AC) to DC (AC/DC) converter 29, a first light source device 25, and a second light source device 27. As compared to the light source apparatus 1 in FIG. 1A, the light source apparatus 2 of this embodiment further comprises an AC/DC converter 29. Both the first light source device 25 and the second light source device 27 are electrically connected to the control circuit 23. The AC/DC converter 29 is electrically connected to the control circuit 23 and the electric-conductive terminal 21. Furthermore, both the control circuit 23 and the AC/DC converter 29 are disposed in a receiving space (not shown) defined by the electric-conductive terminal 21.

If the electric-conductive terminal 21 is electrically connected to a switch 28 and the switch 28 is electrically connected to an AC voltage source 20, then the light source apparatus 2 can operate. The user may initiate the light source apparatus 2 by activating the switch 28 (e.g., pressing the switch 28 once). After the light source apparatus 2 is initiated, the AC voltage source 20 supplies an AC voltage 205. The AC/DC converter 29 receives the AC voltage 205 and then converts the AC voltage 205 into a DC voltage 203. In the second embodiment, after the light source apparatus 2 is initiated, the first light source device 25 has a first brightness, and the second light source device 27 has a third light source brightness.

When the user activates the switch 28 again by pressing the switch 28 once (or pressing the switch 28 multiple times), the switch 28 generates a switching signal 201. When the switching signal 201 is detected by the control circuit 23, the control circuit 23 enables the first light source device 25 to change from the first brightness to a second brightness and enables the second light source device 27 to change from the third brightness to a fourth brightness. When the user activates the switch 28 by pressing the switch 28 multiple times, the switching signal 201 generated by the switch 28 comprises a plurality of switching sub-signals. It shall be appreciated that the values of the first brightness, the second brightness, the third brightness and the fourth brightness may be preset by the control circuit 23.

Hereinbelow, an implementation of the control circuit 23 of this embodiment will be illustrated. The control circuit 23 may comprise a light coupler 231, a voltage regulation circuit 233, a microprocessor 235, and an energy storage circuit 237. The energy storage circuit 237 is electrically connected to the first light source device 25 and the second light source device 27, configured to store the DC voltage 203, and supplies the stored DC voltage 203 to the first light source device 25 and the second light source device 27. Specifically, since the voltage source of the light source apparatus 2 is the AC voltage source 20, the light source apparatus 2 receives no power at certain time instants; in those cases, the energy storage circuit 237 can continuously supply the DC voltage 203 to the first light source device 25 and the second light source device 27. It shall be appreciated that the energy storage circuit 237 may be a capacitive energy storage circuit.

Then, in this embodiment, the light coupler 231 is electrically connected to the AC/DC converter 29. The functions and operations of the light coupler 231 shall be readily known by those of ordinary skill in the art and thus, will not be further described herein. The voltage regulation circuit 233 is electrically connected to the AC/DC converter 29, the energy storage circuit 237, the first light source device 25, and the second light source device 27. The voltage regulation circuit 233 receives the DC voltage 203 from the AC/DC converter 29 and then supplies a stable operating voltage to the first light source device 25 and the second light source device 27. The microprocessor 235 is electrically connected to the light coupler 231, the voltage regulation circuit 233, and the energy storage circuit 237.

The light source apparatus 2 of the second embodiment can be designed to be switched in the same way as the light source apparatus 1 of the first embodiment and this will not be further described herein. The light source apparatus 2 can also decide how to change the brightnesses of the first light source device 25 and the second light source device 27 according to a previous-stage status and the contents of the switching signal 201. In this embodiment, the microprocessor 235 is used to record the previous-stage status of the light source apparatus 2 (i.e., the brightnesses of the first light source device 25 and the second light source device 27 in the previous stage). Supposing that the first light source device 25 has the first brightness and the second light source device 27 has the third brightness in the previous stage, then the microprocessor 235 enables the first light source device 25 to change from the first brightness to the second brightness and enables the second light source device 27 to change from the third brightness to the fourth brightness according to the switching signal 201 and the previous-stage status.

For example, the first brightness may be a maximum brightness of the first light source device 25, the second brightness may be a full-dark status, the third brightness may be a full-dark status, and the fourth brightness may be a maximum brightness of the second light source device 27. Alternatively, the first brightness may be the maximum brightness of the first light source device 25, the second brightness may be a half of the first brightness, the third brightness may be a full-dark status, and the fourth brightness may be a half of the maximum brightness of the second light source device 27. Alternatively, the first brightness may also be a half of the maximum brightness of the first light source device 25, the second brightness may be the maximum brightness of the first light source device 25, the third brightness may be a half of the maximum brightness of the second light source device 27, and the fourth brightness may be a full-dark status.

Similarly, the aforementioned examples may be integrated in the control circuit 23 to provide a multi-stage brightness control. Taking the three-stage brightness control as an example, a first stage may be that the first light source device 25 has the maximum brightness and the second light source device 27 is in the full-dark status, a second stage may be that the first light source device 25 is in the full-dark status and the second light source device 27 has the maximum brightness, and a third stage may be that the first light source device 25 has a half of the maximum brightness thereof and the second light source device 27 has a half of the maximum brightness thereof. The microprocessor 235 records the previous-stage status of the light source apparatus 2, and then decides which stage of the brightnesses shall be presented according to the number of switching sub-signals comprised in the received switching signal 201. For example, if the previous stage is the second stage and the switching signal 201 comprises two switching sub-signals, then the microprocessor 235 controls the first light source device 25 and the second light source device 27 to change from the brightnesses of the second stage to the brightnesses of the first stage.

It shall be appreciated that similar to the first embodiment, the control circuit 23 controls the brightnesses of the first light source device 25 and the second light source device 27 by controlling power levels thereof, and this will not be further described herein.

In a preferred embodiment, the first light source device 25 may comprise a plurality of first light source sub-devices and the second light source device 27 may comprise a plurality of second light source sub-devices. The first light source sub-devices and the second light source sub-devices may each be a light emitting diode (LED). In this embodiment, the first light source device 25 and the second light source device 27 are LEDs having different color temperatures. For examples, the LEDs of the first light source device 25 may have a color temperature ranging between 2000K and 3000K and the LEDs of the second light source device 27 may have a color temperature ranging between 5000K and 9000K, or vice versa.

Furthermore, similar to the first embodiment, when the first light source sub-devices and the second light source sub-devices are arranged alternately, the brightness will become more uniform, so a desired effect can be provided.

It shall be appreciated that the values of the first brightness, the second brightness, the third brightness and the fourth brightness described in the first embodiment and the second embodiment are only for purpose of illustration, but are not intended to limit the scope of the present invention. In other words, the user may set different values for the first brightness, the second brightness, the third brightness, and the fourth brightness according to his or her demands. Furthermore, the color temperatures of the first light source device and the second light source device are not limited to ranging between 2000K and 3000K and ranging between 5000K and 9000K, and instead, the user may also choose light source devices having different color temperatures according to his or her demands.

According to the above descriptions, the light source apparatus of the present invention comprises at least two different light source devices and a control circuit capable of adjusting the at least two light source devices. The user can switch the light source apparatus via a switch. When a switching signal generated by the switch is received by the control circuit, the control circuit can automatically switch and adjust the brightnesses of the light source devices. Furthermore, because the control circuit of the present invention is disposed in a receiving space defined by the electric-conductive terminal, any of the light source devices can be replaced directly when being damaged. In this way, the difficulty in replacing or maintaining the control circuit of the conventional light source apparatus in the prior art can be avoided.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light source apparatus, comprising:
an electric-conductive terminal, defining a receiving space;
a control circuit, being disposed in the receiving space of the electric-conductive terminal and electrically connected to the electric-conductive terminal;
a first light source device, being electrically connected to the control circuit; and
a second light source device, being electrically connected to the control circuit;
wherein when a switching signal is detected by the control circuit, the control circuit enables the first light source device to change from a first brightness to a second brightness and enables the second light source device to change from a third brightness to a fourth brightness.

2. The light source apparatus as claimed in claim 1, wherein the electric-conductive terminal is electrically connected to a direct current (DC) voltage source, and receives a DC voltage from the DC voltage source.

3. The light source apparatus as claimed in claim 1, further comprising:
an alternating current (AC) to DC (AC/DC) converter, being electrically connected to the control circuit and the electric-conductive terminal, and being configured to receive an AC voltage and convert the AC voltage into a DC voltage;
wherein the control circuit comprises an energy storage circuit, and the energy storage is electrically connected to the first light source device and the second light source device to store the DC voltage and supply the DC voltage to the first light source device and the second light source device.

4. The light source apparatus as claimed in claim 3, wherein the control circuit further comprises:
a light coupler, being electrically connected to the AC/DC converter;
a voltage regulation circuit, being electrically connected to the AC/DC converter, the energy storage circuit, the first light source device, and the second light source device; and
a microprocessor, being electrically connected to the light coupler, the energy storage circuit and the voltage regulation circuit.

5. The light source apparatus as claimed in claim 4, wherein the microprocessor further records a previous-stage status of the light source apparatus, and enables the first light source device to change from the first brightness to the second brightness and enables the second light source device to change from the third brightness to the fourth brightness according to the switching signal and the previous-stage status.

6. The light source apparatus as claimed in claim 1, further comprising a switch, wherein when the switch is activated, the switching signal is detected by the control circuit.

7. The light source apparatus as claimed in claim 1, wherein the switching signal comprises a plurality of switching sub-signals.

8. The light source apparatus as claimed in claim 1, wherein the first light source device comprises a plurality of first light source sub-devices and the second light source device comprises a plurality of second light source sub-devices, and the first light source sub-devices and the second light source sub-devices are arranged alternately.

9. The light source apparatus as claimed in claim 1, wherein the first light source device has a color temperature ranging between 2000K and 3000K, and the second light source device has a color temperature ranging between 5000K and 9000K.

10. The light source apparatus as claimed in claim 1, wherein the first brightness is a maximum brightness of the first light source device, the second brightness is a full-dark status, the third brightness is a full-dark status, and the fourth brightness is a maximum brightness of the second light source device.

11. The light source apparatus as claimed in claim 1, wherein the first brightness is a maximum brightness of the first light source device, the second brightness is a half of the first brightness, the third brightness is a full-dark status, and the fourth brightness is a half of a maximum brightness of the second light source device.

12. The light source apparatus as claimed in claim 1, wherein the first brightness is a half of a maximum brightness of the first light source device, the second brightness is the maximum brightness of the first light source device, the third brightness is a half of a maximum brightness of the second light source device, and the fourth brightness is a full-dark status.
